(19) United States
(12) Patent Application Publication
(10) Pub. No.: US 2022/0204847 A1
(43) Pub. Date: Jun. 30, 2022

(54) Method of Biopolymer Soil Additive

(71) Applicant: Nick Nicholas, Maitland, FL (US)

(72) Inventor: Nick Nicholas, Maitland, FL (US)

(21) Appl. No.: 17/247,842

(22) Filed: Dec. 26, 2020

(51) Int. Cl. C09K 17/04; C09K 17/40

(52) U.S. Cl. CPC C09K 17/04; C09K 2101/00; C09K 17/40

(57) ABSTRACT

Provided is a method of bio polymer soil additive used in both lawns, landscaping, agriculture and horticulture plant, vegetable, fruit growing operations.

This bio polymer soil additive contains a blend of zeolite organic mineral compounds and a bio-polymer compound with ion exchange, anti-bacterial and anti-viral properties to enhance plant growth and prevent plant disease.

This soil additive is used in landscaping, agricultural field and horticultural greenhouse operations to enhance plant, vegetable, and fruit production yield while reducing cost of fertilizer usage and the damaging effects of soil eutrophication on the environment.

### BACKGROUND OF INVENTION

### 1. Field of Invention

This invention relates to the field of agriculture and horticulture. More particularly, this invention relates the field of soil additives, containing an organic mineral component and a natural occurring non-toxic biopolymer compound.

The present invention also relates directly to the enhanced growth of plants, vegetables and fruits through enhanced nutrient availability and to reduced soil leaching through a soil release mechanism of nutrients and water to sustain growth with periods of drought conditions.

### 2. Description of Process

There are several different types of fertilizers, both organic and synthetic in nature. These particular fertilizers however, do not allow plants, vegetables and fruit producing trees/plants

Composition Ingredient Types

In one exemplification of this invention, a proprietary blend of biochar is utilized. Biochar helps in the preparation of soil, including enhancing its nutrient composition ability and moisture content.

Biochar is a product of a pyrolysis process of various bio-organic substances such as leaves, branches, wood shaving, dead tree trunks, biomass and/or a composition thereof.

This product consists of carbon substances with a typical granular or powder consistency. When mixed with other compounds, it can be safely optimized to be easily applied to augment soil quality.

Example methods of biochar preparations include those U.S. Pat. Nos. 9,359,267 assigned to Mississippi State University and 9,486,774 assigned to the Centre de recherche industrielle in Quebec, Canada.

The biochar compositions can contain between 10%-30%, most preferably based on the soil type and application.

Zeolite is a type of mined inorganic minerals produced from ancient volcanic deposits having specific compositions and capabilities for cation ion exchange in soils.

This product consists of a loosely bonded microporous natural hydrated aluminosilicate tetrahedral molecular structure, which has certain cation exchange capabilities for enhancing soil qualities for agriculture, horticulture as well as other specific applications. When mixed with other compounds such as biochar, it can be utilized to be easily applied to optimize soil quality for the enhancement of plant growth, reduction of water usage & soil nutrient eutrophication.

The zeolite mineral composition can contain between 70 wt. % to about 90 wt. %, most preferably based on the soil type and application.

Methods of Preparing the Compositions

The soil additive compositions of the present invention can be prepared in different ways. These methods of providing the soil additive compositions include, but are not limited to, granular or powder forms. The compositions can be blended by mixing the zeolite minerals and biochar blends in certain ratios. Once the preferable composition is mixed, it can be prepared in the desired physical form.

Methods of Using the Compositions

The soil additive compositions can be applied to, but not limited to, soil, compost, including such applications as lawns, gardens, agriculture fields, flower beds, in a dosage specific method.

A benefit of the soil additive compositions is that it can be easily spread in conventional manners. For example, in one aspect of the invention, the soil additive can be spread manually by hand to soil or topsoil. In another aspect of the invention, the soil additive can be spread by a manual soil spreading system. In addition, this soil additive composition can also be spread by fanning machinery suitable to for this purpose. Example farming machinery includes, but is not limited to, fertilizer spreaders, etc.

to utilize these nutrients effectively. This leads to soil nutrients leaching into groundwater and surface water causing harmful algal blooms.

In this particular process, a specific method was developed to compose the specific soil additive compounds in a granular/sub granular bio polymer powder.

The process method described of this biopolymer soil additive, utilizes a combination of minerals, including zeolite, that is organic in nature and non-toxic in granular or subgranular form, and non-toxic bio-polymer compounds to create a bio polymer soil additive for introducing to lawns, agriculture fields and horticulture green house growing operations along with a fertilizer.

These particular non-toxic compounds have ion exchange capabilities, anti-bacterial and anti-viral properties and are able to absorb nutrients and water to allow slow release to plants root systems. This process alleviates issues with nutrient leaching due to inefficient uptake of nutrients.

This particular method also allows for the retention and slow release of water to the plants root system enabling the plants to survive during periods of drought conditions.

### BRIEF SUMMARY OF INVENTION PROCESS

The present invention method comprises of the unique combination of organic zeolite sub granular compounds with a non-toxic bio polymer compound to create a soil additive for enhanced plant growth and health. This bio polymer soil additive is used to increase plant, vegetable, fruit growth by enabling high nutrient bio-availability in the root system as well as water through a slow release mechanism.

This also prevents the leaching of nutrients and loss of water due to drought conditions.

The application rate of this soil additive is based on the particular agriculture or horticulture growing operation. However, typically the application rate for conditioning of the top of the soil, is approximately 40 to 60 pounds per 1,000 square feet or about 1300 to 2,700 pounds per acre.

To enhance soil aeration after plugging of plants, apply 70 to 160 pounds per 1,000 square feet or 2600 to 6,700 pounds per acre based on application and soil type.

However, this application rate can be field adjusted accordingly.

### FIGURE DESCRIPTION

FIG. 1 associated with the application shows a photograph of two cucumbers after they are harvested. The cucumbers in the photograph were each water equally. However, in the photograph the cucumber on the left was fertilized with a commercially available synthetic granular fertilizer. On the right in the photograph the cucumber was fertilized using the model bio-organic soil additive of this invention comprising of a zeolite mineral & biochar blend with organic compost. There was approximately one metric ton of each product per acre of agriculture land for the examples in the photograph.

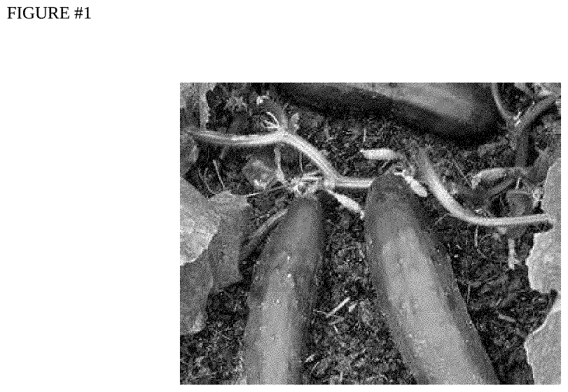

### DETAILED DESCRIPTION

Compositions

The object of this invention is not limited to certain methods of application of this soil additive or using soil types which are understood by a skilled professional in this industry.

It is further implied that the language used in this description is for the purpose of depicting specific characteristics only, and it is not deliberate to be restrictive in any scope or way.

The soil additive compositions can be any suitable form, including, but not limited to, granular or powder forms. In all examples, the soil additive compositions will have controlled release properties to reduce soil nutrient leaching. In preferred examples, the compositions are in the form of granular particles that are free of synthetic materials.

In an aspect of the invention, the soil additive compositions have a desired capability to reduce water irrigation requirements by greater than 25%, and a certain level of cation exchange capability to keep nutrients at the root zone.

Preferably, the soil additive compositions can be utilized with natural compost for organic farming applications having both nitrogen, phosphorus, and potassium.

Additional fertilizers can be chosen with the soil additive based on the composition of the soil type.

Additionally, the compositions can be mixed to optimize costs, sustainability, dosage rates, and growth rates.

The soil additive can be mixed with compost or other fertilizers in the soil according to the specific application and soil composition to optimize plant growth yields and nutritional value. In addition, to reducing water usage and soil eutrophication especially in areas of water scarcity.

1. A soil conditioner or additive composition comprising of:
a specialized inorganic mined zeolite mineral in powder or granular form; and
and a preparation of a biochar granular or powder media composition utilizing a pyrolysis process with feed stock from natural wood and related forest products.
wherein the inorganic mined zeolite mineral compounds are blended and mixed with the biochar blended granular media composition in specific ratios.

2. The composition of claim 1, wherein the biochar compounds can further comprise of leaves, branches, dead tree trunks, wood shaving, biomass and/or combinations thereof

3. The composition of claim 1, wherein the composition comprises two or more types of zeolite mineral compounds.

4. The composition of claim 1, wherein the specialized inorganic mined zeolite mineral is present in the composition from about 70 wt. % to about 90 wt. %; and wherein the biochar compounds are present in an amount from about 10 wt. % to about 30 wt. %.

5. The composition of claim 1 wherein the specific zeolite compounds have a high CEC (cation exchange capacity) and a unique ability to absorb specific cations in soils.

6. The composition of claim 1 comprising one or more of the following additional items to be mixed with the conditioning composition at the time of planting: compost, organic fertilizer compounds, conventional fertilizer compounds.

7. A method of introducing the composition of claim 1 to the soil:
(a) by means of a granular media spreader; and
(b) applying the soil additive composition by hand or by agriculture tractor machine spreading mechanism.
